(19) United States
(12) Patent Application Publication
(10) Pub. No.: US 2022/0366284 A1
(43) Pub. Date: Nov. 17, 2022

(54) EFFICIENT COMPUTATIONAL INFERENCE

(71) Applicant: SECONDMIND LIMITED, CAMBRIDGESHIRE (GB)

(72) Inventors: Vincent Adam, Cambridge (GB); Stephanos Eleftheriadis, Cambridge (GB); Nicholas Durrande, Cambridge (GB); Artem Artemev, Cambridge (GB); James Hensman, Cambridge (GB); Lucas Bordeaux, Cambridge (GB)

(73) Assignee: SECONDMIND LIMITED, CAMBRIDGESHIRE (GB)

(21) Appl. No.: 17/753,723

(22) PCT Filed: Nov. 14, 2019
(86) PCT No.: PCT/EP2019/081394

§ 371 Date: Mar. 11, 2022

(30) Foreign Application Priority Data
Sep. 20, 2019 (GR) 20190100406

(51) Int. Cl. G06N 7/00; G06N 20/00

(52) U.S. Cl. CPC G06N 7/005; G06N 20/00

(57) ABSTRACT

A computer-implemented method of processing data comprising a plurality of observations associated with respective ordered input values to train a Gaussian process (GP) to model the data. The method includes initialising an ordered plurality of inducing input locations, and initialising parameters of a multivariate Gaussian distribution over a set of inducing states, each inducing state having components corresponding to a Markovian GP and one or more derivatives of the Markovian GP at a respective one of the inducing inputs. The initialised parameters include a mean vector and a banded Cholesky factor of a precision matrix for the multivariate Gaussian distribution. The method further includes iteratively modifying the parameters of the multivariate Gaussian distribution, to increase or decrease an objective function corresponding to a variational lower bound of a marginal log-likelihood of the observations under the Markovian GP.

### TECHNICAL FIELD

The present invention relates to the computational implementation of Gaussian process models.

### BACKGROUND

Gaussian process (GP) models provide a powerful and flexible means of inferring statistical information from empirical data. GP models have been applied in various contexts in machine learning, for example in regression and classification tasks, and also for predicting states of an environment in a reinforcement learning system, as described in European patent publications EP3467717 and EP3467718.

Certain GP models are well-suited to the modelling of time-series data such as a sequence of audio samples, a sequence of measurements of neural activity in a human or animal brain, and a sequence of measurements of physical states of a dynamical system. For such time-series data, empirical observations are assumed to be noisy realisations of an unobservable latent process encoding statistical properties of an underlying signal. GP models offer strong guarantees of accuracy and automatically yield well-calibrated uncertainty estimations. However, both in terms of computational operations and in terms of memory requirements, most computational implementations of GP models scale poorly with the size of an empirical dataset. This poor scalability has tended to limit the viability of GP models as an alternative to neural network-based models across a range of technical fields. Furthermore, in cases where a data signal is received in a streaming fashion (as is often the case for time-series data), existing GP methods require batch processing of historical data and in many cases do not provide the necessary efficiency for real-time analysis of the streamed data.

In a typical GP inference task, the objective is to fit a latent GP to an observed dataset D={(xₙ, yₙ)}ₙ₌₁^{N} such that the resultant GP can be used to predict a distribution of an output value y* at an unobserved input location x*, or alternatively to determine properties of a signal underlying the data. This description encapsulates regression, in which an output y corresponds to one or more attributes of a corresponding input x, and classification, in which an output y corresponds to a probability of an input x being associated with a given class.

GP models are conventionally defined using a kernel representation, which consists of a GP prior and an observation model as shown in Equation (1):

p(ƒ(⋅))=P(μ(⋅),k(⋅,⋅′)), p(y|f(⋅))=Πₙ₌₁^{N}p(yₙ|ƒ(⋅)), (1)

where y={yₙ}ₙ₌₁^{N} and it has been assumed that the likelihood p(y|ƒ(⋅)) factorizes over the dataset D. The prior density p(ƒ(⋅)) of the GP depends on a mean function μ(⋅) and a kernel k(⋅,⋅′), where ⋅ and ⋅′ denote unspecified input locations. The aim of GP inference is to determine or approximate a posterior process p(ƒ(⋅)|y) corresponding to the GP prior conditioned on the dataset D.

In addition to the kernel representation of Equation (1), certain GP models admit a state space representation in which a state vector s(t)∈ [symbol] ^{d} has components given by evaluations of the GP and the first d−1 derivatives of the GP, such that s(t)=[ƒ(t), ƒ⁽¹⁾(t), . . . , ƒ^{(d-1)}(t)]^{T}, where T denotes the transpose. In such models, the state vector s(t) satisfies a linear time-invariant (LTI) stochastic differential equation (SDE) given by Equation (2):

\dot{s}=Fs(t)+L∈(t), ƒ(t)=Hs(t), (2)

where \dot{s} denotes the derivative of s with respect to time. The r-dimensional vector ε(t)∈ [symbol] ^{r} is a white noise process with spectral density Q_{c}, i.e. an infinite collection of indexed uncorrelated random variables with zero mean and finite variance. The coefficients F∈ [symbol] ^{d×d}, L∈ [symbol] ^{d×r}, H∈ [symbol] ^{1×d}, along with the dimension d of the state vector s, can be derived for different choices of kernel in the kernel representation of Equation (1). Although the input locations in this example are represented by t to indicate temporal indexes, the LTI-SDE representation of Equation (2) is not limited to time-series data, and the input locations may alternatively represent spatial positions or other ordered indexes. Mappings between specific kernel functions and coefficients in the state-space representation are known, with various examples being set out, for example, in the textbook Applied stochastic differential equations, Simo Särkkä and Arno Solin, Cambridge University Press, 2019. Note that, although the state-space model of Equation (2) has been introduced here as an alternative representation of the kernel model of Equation (1), in certain applications a state-space model may be derived directly from a dynamics model of a system and an observation model, without reference to any kernel representation. One such example is where data correspond to noisy observations of a dynamical system. The present invention is equally applicable in either of these contexts.

The marginal distribution of solutions to the LTI-SDE system of Equation (2) evaluated at an ordered set of input values [t₁, . . . , t_{N}]^{T} follows a discrete-time linear system given by Equation (3):

$$s ( {t}_{n + 1} ) = {A}_{n , n + 1} s ( {t}_{n} ) + {q}_{n} , {q}_{n} ∼ N ( 0 , {Q}_{n , n + 1} ) , \qquad ( 3 )$$

$$s ( {t}_{0} ) ∼ N ( 0 , {P}_{0} ) , f ( {t}_{n + 1} ) = Hs ( {t}_{n + 1} ) ,$$

for n=0, . . . N−1, where P₀ is the initial state covariance matrix. The state transition matrices A_{n,n+1}∈R^{d×d} and the noise covariance matrices Q_{n,n+1}∈R^{d×d} have analytical expressions given by:

A_{n,n+1}=exp(FΔₙ), (4)

Q_{n,n+1}=∫₀^{Δ}^{ₙ}exp(Δₙ−τ)LQ_{c}L^{T}exp(Δₙ−τ)^{T}dτ, (5)

where Δₙ=tₙ₊₁−tₙ. It is observed that the distribution for each state depends only on the previous state in the sequence. This property is referred to as the Markov property, and the GP is therefore an example of a hidden Markov model. FIG. 1 is a graphical model showing the dependence between four successive states sᵢ=s(tᵢ) for input values tᵢ with i=1,2,3,4, illustrating the Markov property between the four states.

A smoothing solution of the LTI-SDE system of Equation (2) corresponds to the posterior density p(ƒ(⋅)|y) of the GP conditioned on the data in the kernel representation of Equation (1). Determining a smoothing solution of the LTI-SDE system is therefore equivalent to performing GP inference using the corresponding kernel representation.

Whereas the computational cost of performing exact GP inference using the kernel representation scales cubically with the size of the dataset, for conjugate likelihood models (i.e. regression in which the likelihood is assumed to be Gaussian), a smoothing solution to the LTI-SDE can be determined by applying Kalman filters and Raugh-Tung-Striebel (RTS) smoothers to the discrete-time linear system of Equation (3), resulting in a computational cost that scales linearly with the size of the dataset. Although this represents a significant improvement in computational cost compared with the cubic scaling of the kernel-based implementation mentioned above, in order to incorporate new data the Kalman/RTS method requires a forward and reverse pass through the entire dataset, which can still be prohibitive, for example in cases where time-series data is streamed at a high rate. Furthermore, the Kalman/RTS method does not extend to models with non-conjugate likelihoods or to composite models such as deep GP (DGP) models. As such, neither the Kalman/RTS method, nor existing kernel methods, are generally suitable for real-time analysis of data signals.

### SUMMARY

According to a first aspect of the present invention, there is provided a computer-implemented method of processing data comprising a plurality of observations associated with respective ordered input values to train a Gaussian process (GP) to model the data. The method includes initialising an ordered plurality of inducing inputs, and initialising parameters of a multivariate Gaussian distribution over a set of inducing states, each inducing state having components corresponding to a Markovian GP and one or more derivatives of the Markovian GP at a respective one of the inducing inputs. The initialised parameters include a mean vector and a banded Cholesky factor of a precision matrix for the multivariate Gaussian distribution. The method further includes iteratively modifying the parameters of the multivariate Gaussian distribution, to increase or decrease an objective function corresponding to a variational lower bound of a marginal log-likelihood of the observations under the Markovian GP.

The parameterisation of the Markovian GP described above results in an inference scheme with unexpected favourable properties which have not previously been exploited and which allow for a GP model to be implemented at a greater speed, requiring less memory usage, and with greater scalability than any existing method. The resulting method is carried out efficiently using reverse-mode differentiation, making the present invention suitable for implementation using well-developed automatic differentiation frameworks. The method is more scalable and better suited to the real-time analysis of data signals than the Kalman/RTS method and existing kernel-based methods.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a graphical model illustrating the dependence of a sequence of states in a state-space representation of a Gaussian process model.

FIGS. 2a and 2b are graphical models illustrating the dependence of a sequence of states and inducing states in a state-space representation of a Gaussian process model in accordance with an embodiment of the present invention.

FIG. 3 shows a variational GP being used to model a sequence of time-series data in accordance with an embodiment of the present invention.

FIGS. 4a-c schematically show sparse and compact storage of a symmetric block-tridiagonal matrix and a lower block-bidiagonal matrix.

FIGS. 5a and 5b show a sampled audio signal at two different times.

FIG. 6 shows a data processing system arranged to perform statistical inference in accordance with an embodiment of the present invention.

FIG. 7 shows schematically a method of performing statistical inference in accordance with an embodiment of the present invention.

FIG. 8 shows schematically a deep Gaussian process model with layers in accordance with an embodiment of the present invention.

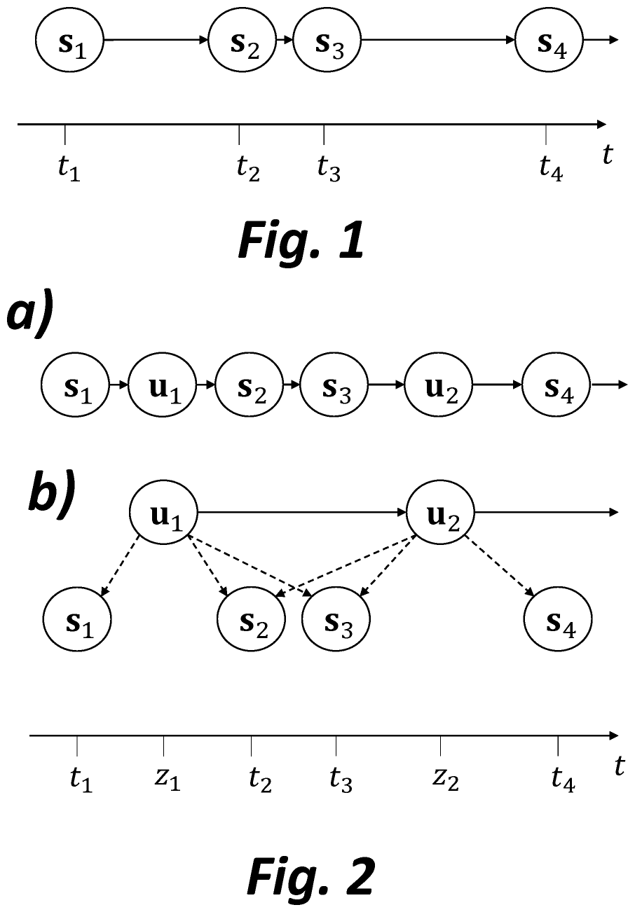

### DETAILED DESCRIPTION

The present invention relates to a computationally efficient method of performing statistical inference using Markovian GP models. The method is based on sparse variational inference, in which a variational GP is defined entirely by its marginal statistics at a set of inducing inputs, as opposed to data input values. Using inducing inputs significantly reduces the computational cost of the training process provided that the number M of inducing points is much smaller than the number N of observations in the dataset being modelled, i.e. M<<N.

In accordance with the present invention, a set u={uᵢ}ᵢ₌₁^{M} of inducing states uₜ is defined at an ordered set of inducing inputs {zᵢ}ᵢ₌₁^{M}, where uᵢ=s(zᵢ). The inducing states are an example of inter-domain inducing features, because the states are not simply evaluations of the GP at the inducing input locations (but rather, the inducing states also carry information about derivatives of the GP at the inducing input locations), and therefore exist in a different domain to the GP. The prior distribution of the inducing states satisfies the Markov property and inherits a multivariate Gaussian distribution p(u)=N(u; μ_{ψ}, Q_{ψ}⁻¹) from the variational GP with mean vector μ_{ψ}∈ [symbol] ^{Md} and precision matrix Q_{ψ}∈ [symbol] ^{Md×Md}, which has an analytical expression in [symbol] terms of the parameters of discrete-time linear system (3). The Markov property of the inducing states advantageously results in the precision matrix being block-tridiagonal, such all elements of the precision matrix not contained within a row of three d×d blocks centred on the leading diagonal are zero. A block-tridiagonal matrix is an example of a banded matrix, because all non-zero elements lie within a diagonal band containing the leading diagonal, along with 2d−1 upper diagonals and 2d−1 lower diagonals. The precision matrix is said to have a bandwidth of 1=2d−1 (the maximum of the number of lower diagonals and the number of upper diagonals). The precision matrix is symmetric and positive definite, and can therefore be decomposed as Q_{ψ}=L_{ψ}L_{ψ}^{T}, where the Cholesky factor Le is a lower block-bidiagonal matrix.

In order to perform sparse variational inference, a sparse variational GP q(ƒ(⋅)) is introduced to approximate the posterior process p(ƒ(⋅)|y), as given by Equation (6):

q(ƒ(⋅))=∫p(ƒ(⋅)|u)q(u)du, (6)

where p(ƒ(⋅)|u) is used as a shorthand to denote p(ƒ(⋅)|{s(zᵢ)=uᵢ}ᵢ₌₁^{M}). The sparse variational GP is thus given by the GP prior conditioned on the inducing states and marginalised over a variational Gaussian distribution q(u)=N(u; μᵤ, Σᵤᵤ) for the inducing states. The training process involves iteratively modifying parameters of the variational Gaussian distribution q(u), along with (optionally) the inducing input locations and any hyperparameters of the kernel k and mean function μ (or, equivalently, coefficients of the corresponding LTI-SDE system), and parameters of the likelihood, in order to minimise the Kullback-Leibler (KL) divergence between the variational GP q(ƒ(⋅)) evaluated at the observed data points and the Bayesian posterior p(ƒ(⋅)|y) evaluated at the observed data points. The KL divergence is given by Equation (7):

KL[q(ƒ)∥p(f|y)]=log p(y)− [symbol] , (7)

where

$$ℒ = {\sum }_{n = 1}^{N} {𝔼}_{q ( f ( {t}_{n} ) )} [ log p ( {y}_{n} \vert f ( {t}_{n} ) ) ] - KL [ q ( u ) \vert \vert p ( u ) ] , \qquad ( 8 )$$

and f={ƒ(tₙ)}ₙ₌₁^{N}. The KL divergence in Equation (7) is non-negative, with equality when the variational GP q(ƒ(⋅)) matches the Bayesian posterior process p(ƒ(⋅)|y). The quantity [symbol] is therefore a variational lower bound of the [symbol] marginal log-likelihood log p(y). Maximising the variational bound [symbol] with respect to the inducing input locations and the parameters of the variational distribution q(u) minimises the KL divergence between the variational GP and the Bayesian posterior process. Maximising the variational bound with respect to the hyperparameters maximises the marginal likelihood log p(y) of the data, or in other words how well the exact model fits the data. By treating the variational bound as an objective function to be maximised with respect to the inducing inputs, the parameters of the variational distribution over inducing states, and the hyperparameters simultaneously, over a series of training iterations the variational GP tends towards a Bayesian posterior process for an optimal GP prior.

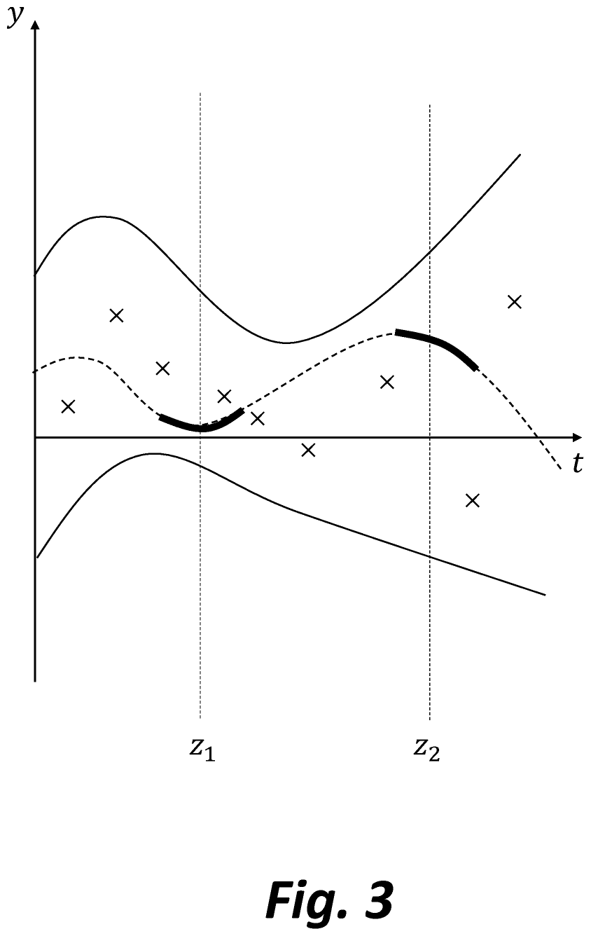

FIG. 3 shows an example of a sparse variational GP trained to fit a dataset in a time-series regression problem. Time-series data {(tₙ, yₙ)}ₙ₌₁^{N} are shown as crosses and solid thin curves represent a single standard deviation above and below the mean function of the variational GP. The dashed curve shows a latent function ƒ resulting from two sampled inducing states u₁˜q(s(z₁)) and u₂˜q(s(z₂)). In this example, the GP prior p(ƒ(⋅)) admits a three-dimensional state-space representation (d=3). The thick solid curves show the first three terms of the local Taylor expansion of the latent function ƒ at the inducing inputs z₁, z₂, illustrating the information contained within the sampled inducing states u₁, u₂.

Given the state-space representation described above, the joint prior distribution of state vectors indexed at the data input locations and the inducing inputs satisfies the Markov property as shown in FIG. 2a. A key insight of the present invention is that the variational posterior distribution q(u) independently satisfies the Markov property as shown by the solid arrows in FIG. 2b, and the conditional distribution p(s(tₙ)|u) for a given state s(tₙ) depends only on the closest left and right neighbouring inducing states, as shown by the dashed arrows in FIG. 2b. The conditional dependence of the GP on the inducing states follows from this, and satisfies Equation (9):

p(ƒ(tₙ)|u)=p(ƒ(tₙ)|uₙ₋,uₙ₊), (9)

where u_{n±}=s(z_{n±}) with z_{n±} being the neighbouring inducing inputs to to such that z₁< . . . <zₙ₋<tₙ<zₙ₊< . . . <z_{M}. Denoting the marginal variational distribution of the inducing state pair vₙ=[uₙ₋; uₙ₊] by q(vₙ)=N(vₙ; μᵥ_{ₙ}, Σᵥ_{ₙ}ᵥ_{ₙ}), the predictive posterior distribution of a state vector at a given input location is given in terms of the parameters of the linear system by Equation (10):

q(s(tₙ))=N(s(tₙ);Pₙμᵥ_{ₙ},Tₙ+PₙΣᵥ_{ₙ}ᵥ_{ₙ}Pₙ^{T}) (10)

where:

Pₙ=[A_{n-,n}−Q_{n-,n}A_{n,n+}^{T}Rₙ⁻¹A_{n-,n+},Q_{n-,n}A_{n,n+}^{T}Rₙ⁻¹], (11)

Tₙ=(Q_{n-,n}⁻¹+A_{n,n+}^{T}Q_{n,n+}⁻¹A_{n,n+})⁻¹, (12)

Rₙ=Q_{n,n+}+A_{n,n+}Q_{n-,n}A_{n,n+}. (13)

The predictive posterior distribution q(s(tₙ)) depends on the marginal covariance Σᵥ_{ₙ}ᵥ_{ₙ} of the neighbouring inducing states, which is a 2d×2d matrix formed of neighbouring block-tridiagonal elements of the dense covariance matrix Σᵤᵤ. A further key insight of the present invention is that the optimal precision matrix Qᵤᵤ*≡Σᵤᵤ*⁻¹ of the variational Gaussian distribution q(u) is a symmetric block-tridiagonal matrix, and can therefore be decomposed as Qᵤ*=Lᵤ*Lᵤ*^{T}, where the Cholesky factor Lᵤ* is a lower block-bidiagonal matrix. In accordance with the present invention, the variational precision matrix Qᵤᵤ is parameterised to reflect the form of the optimal precision matrix such that Qᵤᵤ=LᵤLᵤ^{T} where the Cholesky factor Lᵤ is restricted to being a banded matrix of sufficient bandwidth to contain the non-zero elements of a lower block-bidiagonal matrix of block size d (i.e. a bandwidth of at least l=2d−1). In one implementation, the Cholesky factor Lᵤ is restricted to being a lower block-bidiagonal matrix.

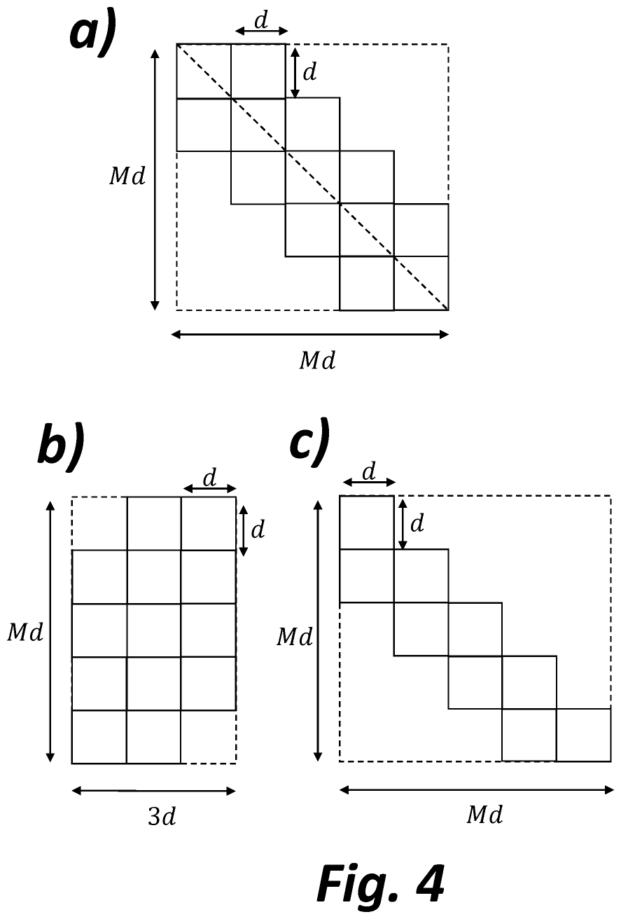

The sparseness and symmetry of the precision matrices Qᵤᵤ and Q_{ψ} allows for compact storage such that only the in-band elements are stored, because the other elements are guaranteed to be zero. In one example, the in-band elements are stored compactly as a dense matrix of size Md×(2l+1) (with rows of the dense matrix having elements equal to the in-band elements of the corresponding sparse matrix). In other examples, blocks of the block-banded matrices are arranged for compact storage. FIG. 4a shows a block-tridiagonal matrix with the same sparseness pattern as the precision matrix Qᵤᵤ and Q_{ψ}, and FIG. 4b shows an example of compact storage of the matrix of FIG. 4a, in which the blocks are arranged in three columns (with the top-left and bottom-right blocks being redundant). Storing the precision matrices compactly reduces the memory required to be allocated to storing the precision matrices from O(M²d²) to O(Md²). Furthermore, the Cholesky factors L_{ψ} and Lᵤ are banded matrices, and can similarly be compactly stored as dense matrices. In some examples, the Cholesky factors are restricted to being lower block-bidiagonal matrices as shown in FIG. 4c, and can be stored compactly by arranging the blocks in two columns as shown in FIG. 4b. Reducing the memory usage by compact storage of sparse matrices (i.e. by arranging the elements in a predetermined manner to form a corresponding dense matrix) is particularly advantageous where available memory is limited, for example when the present method is performed using a compact device such as a smartphone or a tablet computer. Such devices may only be able to allocate a small memory region to the inference process, especially if multiple applications or processes are running simultaneously.

The block-tridiagonal form of the variational precision matrix Qᵤᵤ allows for the marginal covariances Σᵥ_{ₙ}ᵥ_{ₙ} for pairs of neighbouring inducing states (each being a 2d×2d block of block-tridiagonal elements of the dense covariance matrix Σᵤᵤ) to be computed from the Cholesky factor Lᵤ using a sparse inverse subset operator (described in more detail below) at a computational cost of 0 (Md²) operations. The matrix operations required to determine each marginal posterior density at the data points then adds a further computational cost of 0 (d³) operations. The computational cost of evaluating the expectation terms in the objective function [symbol] (or of estimating the expectation values in the case of non-conjugate likelihood models) is therefore O(Md²+Nd³) operations. Furthermore, the gradient of the expectation terms with respect to the parameters of the model has the same scaling by making use of reverse mode sensitivities, as described in more detail hereafter. An unbiased estimator of the sum of expectation terms (and the gradient of the sum of expectation terms) can be determined by randomly sampling a subset of the data of size N_{b}<<N, referred to as a mini-batch, relabelling the indices to be ordered within the mini-batch, and determining an estimator for the sum of expectation terms on the basis of the min-batch only. Mini-batching in this way reduces the computational cost to O(Md²+N_{b}d³) operations.

The KL divergence term in Equation (8) is given by Equation (14):

$$KL [ q ( u ) \vert \vert p ( u ) ] = \frac{1}{2} ( Tr ( {Σ}_{uu} {Q}_{ψ} ) + {( {µ}_{ψ} - {µ}_{u} )}^{T} {Q}_{ψ} ( {µ}_{ψ} - {µ}_{u} ) - M + log ( det {L}_{u} {L}_{u}^{T} ) - log ( det {L}_{ψ} {L}_{ψ} ) ) . \qquad ( 14 )$$

Only the block-tridiagonal elements of Σᵤᵤ contribute to the trace term, and hence the trace term and its gradient can be evaluated in O(Md²) operations using the sparse inverse subset operator. The computational cost of the log determinants and their gradients is O(Md³) using the Cholesky decompositions of the precision matrices. The overall computational cost of evaluating the objective function [symbol] and its gradient is therefore O((N+M)d³) operations, or O((N_{b}+M)d³) operations when mini-batches are used. It is stressed that the linear computational cost with respect to the number of inducing variables results from the auspicious parameterisation chosen for the variational distribution q(u).

Once the GP model has been trained (i.e. once the parameters of the variational distribution a(u), along with optionally the inducing input location and any hyperparameters have been determined), the distribution q(s(t*)) at an unseen input location t, is readily computed. Furthermore, a prediction at the unseen input location can be made in O(d³) operations by sampling a state vector from the distribution q(s(t_{*})) and then sampling from the conditional likelihood p(y_{*}|ƒ(t_{*})) at the corresponding value of the latent function ƒ(t_{*}). The predictive probability distribution of an observation y_{*} at an unobserved input location t_{*} is given by Equation (15):

$$p ( {y}_{8} \vert y ) = \int p ( {y}_{*} \vert f ( {t}_{*} ) ) p ( f ( {t}_{*} ) \vert y ) df ( {t}_{*} ) \approx \int p ( {y}_{*} \vert f ( {t}_{*} ) ) q ( f ( {t}_{*} ) ) df ( {t}_{*} ) . \qquad ( 15 )$$

In cases where the likelihood is conjugate to the posterior distribution q(ƒ(t_{*})), the integral in Equation (15) can be evaluated analytically. In other examples, numerical methods can be used to estimate the predictive probability, for example Monte Carlo sampling as shown in Equation (16):

$$\int p ( {y}_{*} \vert f ( {t}_{*} ) ) q ( f ( {t}_{*} ) ) d f ( {t}_{*} ) \approx \frac{1}{K} {\sum }_{k = 1}^{K} p ( {y}_{*} \vert {f}^{( k )} ( {t}_{*} ) ) , \qquad ( 16 )$$

where ∫^{(k)}(t_{*})=Hs^{(k)}(t_{*}) with s^{(k)}(t_{*})˜q(s(t_{*})), where K is the number of Monte Carlo samples used to approximate the integral. In other implementations, other numerical methods may be used to approximate the integral of Equation (15), such as Gaussian quadrature.

### Banded Matrix Operations

As explained above, the banded diagonal matrices (block-tridiagonal and lower block-bidiagonal) used in the present formulation result in a dramatically reduced computational cost and memory requirements compared with other methods of implementing GP models. A number of computational operators specific to banded matrices are used to implement the present method. In particular, the following linear algebra operators are required for banded matrices Q, Q₁, Q₂, banded lower triangular matrices L, and vectors v, v₁, v₂:
Cholesky decomposition [symbol] : Q→L such that LL^{T}=Q.
Triangular solve [symbol] : (L, v)→L⁻¹v;
Sparse inverse subset: [symbol] : L→band_{Q}(Q⁻¹);
Reverse sparse inverse subset: [symbol] ⁻¹: band_{Q}(Q⁻¹)→L;
Products: [symbol] : Q₁, Q₂→Q₁Q₂ or Q, v→Qv;
Sparse outer product subset: [symbol] : v₁, v₂→band_{Q}(v₁v₂^{T}),
   where band_{Q} denotes elements in a band corresponding to that of the banded matrix Q. For a banded matrix of size Md×Md and bandwidth d (including the block-tridiagonal and block-bidiagonal matrices mentioned above), the above operators can be implemented at a computational cost of at most O(Md²) operations.

The linear algebra operators described above allow for the objective function [symbol] to be determined (or estimated in the case of a non-conjugate likelihood) in O((N_{b}+M)d³) operations. In order to determine the gradient of [symbol] with respect to the model parameters (including the parameters of the variational distribution q(u) and, optionally, the inducing input locations and any hyperparameters), reverse-mode sensitivities are also required for each of these operators. Reverse-mode sensitivities are derivatives performed in reverse-mode on the output of an operator. With the exception of the reverse sparse subset inverse operator, exemplary implementations of the linear operators above, as well as the associated reverse-mode sensitivities, can be found, for example, in the publication “Banded Matrix Operators for Gaussian Markov Models in the Automatic Differentiation Era”, Durrande et al, AISTATS 2019, the entirety of which is incorporated herein by reference.

For the reverse sparse subset inverse operator [symbol] ⁻¹, a novel operator is constructed as set out in the novel algorithm below, which takes as an input C=band_{Q}(Q⁻¹), where Q is a symmetric banded matrix of bandwidth d, and outputs a banded matrix of lower bandwidth d for which Q=LL^{T}:

Reverse Sparse Inverse Subset
L←0 (initialise L to Md×Md zero matrix)
for i∈[0, . . . , Md−1] do
   c⁽ⁱ⁾←C_{i:i+d,i:i+d} (extract d×d symmetric sub-block at i)
   v⁽ⁱ⁾←(c⁽ⁱ⁾)⁻¹e, e=[1, 0, . . . , 0]∈ [symbol] ^{d}
      (select first column of inverse of sub-block)
   l⁽ⁱ⁾←v⁽ⁱ⁾/\sqrt{v₁⁽ⁱ⁾}
   L_{i:i+d,i}←l⁽ⁱ⁾
return L
   Reverse-mode differentiation through the reverse subset inverse operator is achieved using the following algorithm, which takes the reverse-mode sensitivity L̅≡dƒ/dL of an arbitrary function ƒ with respect to the Cholesky factor L as an input and outputs a matrix C̅≡dƒ/dC which is the reverse-mode sensitivity with respect to C=band_{Q}(Q⁻¹).

Reverse-Mode Differentiation for Reverse Sparse Subset Inverse
C̅←0 (initialise C̅ to Md×Md zero matrix)
for i∈[0, . . . , Md−1] do
   c⁽ⁱ⁾←C_{i:i+d,i:i+d} (extract d×d symmetric sub-block at i)
   l̅⁽ⁱ)←L̅_{i:i+d,}
   c̅⁽ⁱ⁾=−(c⁽ⁱ⁾)⁻¹el̅^{(i)T}Hᵢ(c⁽ⁱ⁾)⁻¹
   C̅_{i:i+d,i:i+d}←C̅_{i:i+d,i:i+d+d}+c̅⁽ⁱ⁾
return C̅
   where

$${H}_{i} = \frac{1}{\sqrt{{v}_{1}^{( i )}}} ( [ \begin{matrix}- {l}_{1}^{( i )} / ( 2 \sqrt{{v}_{1}^{( i )}} ) & … & 0 \\ ⋮ & ⋱ & ⋮ \\ - {l}_{M}^{( i )} / ( 2 \sqrt{{v}_{1}^{( i )}} ) & … & 0\end{matrix} ] + {I}_{d} ) ,$$

and e=[1, 0, . . . , 0]∈ [symbol] ^{d} as before.

In the algorithms above, the determination of the inverse (c⁽ⁱ⁾)⁻¹ of a symmetric sub-block can be achieved by computing the Cholesky factor s⁽ⁱ⁾ and then solving v⁽ⁱ⁾=(s⁽ⁱ⁾)^{-T}(s⁽ⁱ⁾)⁻¹e. The Cholesky factors s⁽ⁱ⁾ can either be computed directly in parallel, or alternatively using an iterative method, where given the Cholesky factor s⁽ⁱ⁾ of c⁽ⁱ⁾, the Cholesky factor s⁽ⁱ⁻¹⁾ of c⁽ⁱ⁻¹⁾ is given by Equation (17):

$${s}^{( i - 1 )} = {chol ( {C}_{i - 1 : i + d , i - 1 : i + d} )}_{1 : d , 1 : d} where \qquad ( 17 )$$

$$chol ( {C}_{i - 1 : i + d , i - 1 : i + d} ) = [ \begin{matrix}\sqrt{{C}_{i - 1 , i - 1}} & 0 \\ {C}_{i - 1 : i + d , i - 1} / \sqrt{{C}_{i - 1 , i - 1}} & chol ( \begin{matrix}{s}^{( i )} {s}^{( i ) T} - \\ {C}_{i - 1 : i + d , i - 1} {C}_{i - 1 : i + d , i - 1}^{T} / {C}_{i - 1 , i - 1}\end{matrix} )\end{matrix} ] .$$

The iterative method results in a computational cost of O(Md²) operations for the reverse sparse inverse subset operator and the associated reverse-mode derivative.

### Real-Time Signal Analysis

The inference method presented herein is particularly advantageous for the real-time or near real-time analysis of data received continually as a data stream. Examples include real-time analysis of audio samples, for example in speech detection, speech recognition, automatic pitch detection and similar applications, modelling of dynamical systems from noisy observations, for example to generate control signals for one or more entities in the dynamical system, and analysis or visualisation of neural activation data in human or animal brains. In the context of machine learning, performing inference in real-time on streamed data is referred to as on-line learning. Until now, GP models have been generally unsuitable for on-line learning because GP inference generally requires the inversion of a dense matrix at each update step. If order for new data to be incorporated, a new dense matrix needs to be inverted, resulting in an O(N³) computational cost at each update, where N is the size of the matrix.

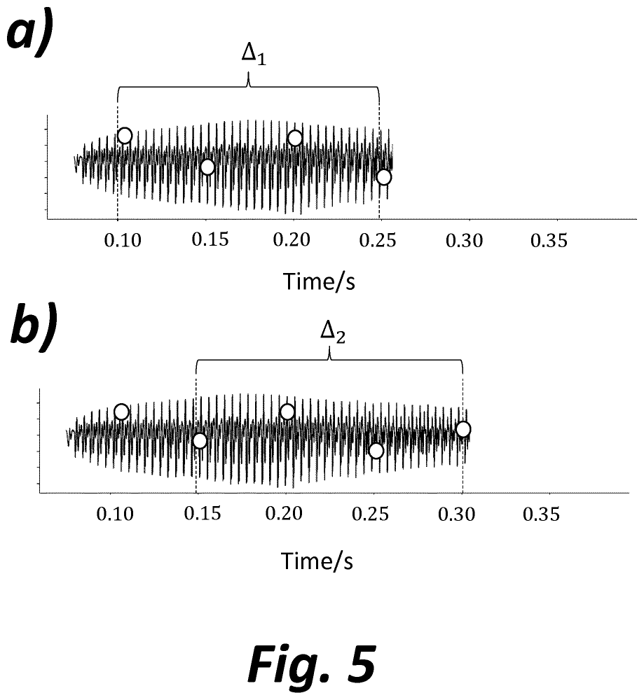

In accordance with certain embodiments of the present invention, data may be received as a data stream and inducing states may be generated sequentially in an on-line manner. For example, new inducing inputs may be initialised concurrently with the receiving of streamed data, either at a predetermined rate or in response to the receiving of observations. Due to the Markov property of the inducing states, the marginal distribution q(uₘ) of a new inducing state may be determined and optimised at a low computational cost. FIG. 5 shows an example of a real sound file representing an uttered vowel from a female speaker sampled at a frequency of 16 kHz. A vowel is typically a quasi-periodic signal where the pitch is fixed but the repeated temporal pattern varies with time. The sound file of FIG. 5 is therefore assumed to be generated by a Markovian GP with a quasi-periodic kernel given by Equation (18):

$$k ( t , {t}^{′} ) = {k}_{mat 3 / 2} ( t , {t}^{′} ) ( {\sum }_{j = 0}^{6} {γ}_{i}^{2} cos ( 2 π {f}_{0} j ( t - {t}^{′} ) ) ) , \qquad ( 18 )$$

where f₀ denotes the fundamental frequency of the pitched sound and k_{mat3/2} denotes the Matérn kernel of order 3/2. The kernel has four hyperparameters: the fundamental frequency ƒ₀ of the periodic variation, the variance γᵢ of the various harmonics, the length-scale l of the Matérn kernel and variance σ² of the Matérn kernel. This kernel has a state-space representation with d=26, and accordingly the methods set out in the present invention can be used to analyse the signal.

In the example of FIG. 5, the audio signal is received by a microphone and analysed in real-time using the method described herein. In the present example, inducing inputs are initialised sequentially at regular 0.05 s intervals. FIG. 5a shows four white circles corresponding to inducing states sampled at inducing inputs {z₁, z₂, z₃, z₄}={0.1,0.15,0.2,0.25}s. The marginal distributions over the four inducing states are determined by optimising an objective function [symbol] for samples in the interval Δ₁=[0.1,0.25]s as described above, for example using mini-batches of observations within this interval, resulting in a computational cost of O((N_{Δ}_{₁}+M_{Δ}_{₁})d³) operations, where N_{Δ}_{₁} is the number of samples used in the interval Δ₁ (which may be a mini-batch of the samples in Δ₁) and M_{Δ}_{₁}=4 is the number of inducing states in the interval Δ₁. In this way, the GP model is fitted to the samples in the interval Δ₁. In addition to the distributions over inducing states, in some examples hyperparameters of the GP model and locations of the inducing inputs are optimised for the interval Δ₁.

In the interval 0.25 s<t<0.3 s, additional samples are received, and a further inducing state u₅ is initialised at time z₅=0.3 s. In the present example, parameters of the model are updated by optimising [symbol] for samples in the interval Δ₂=[0.15,0.3]s for example using mini-batches of observations within this interval, resulting in a computational cost of 0 ((N_{Δ}_{₂}+M_{Δ}_{₂})d³) operations. In this example, the intervals Δ₁ and Δ₂ are of equal duration and contain an equal number of inducing inputs. As such, a window of fixed size (a fixed interval) is moved over the data as the signal is received, resulting in a model that automatically adapts to changes in characteristics of the data. In some examples, an interval is bounded by two inducing inputs and contains no further inducing inputs (i.e. M_{Δ}_{ᵢ}=2), allowing for very rapid adaptive updating of the model. In other examples, multiple inducing states may be initialised before optimisation is performed. Parameters determined for a preceding interval may be used as initial guesses for the new interval. In other examples, intervals may vary in size. For example, the size of an interval may depend on a rate at which data is received.

In some examples, characteristics of a data signal may evolve over time. For example, the pitch of a voice may vary in an audio file representing human speech. In a simple example, the present invention is used to determine a pitch of a voice or other sound from an audio file. The pitch corresponds to the fundamental frequency hyperparameter ƒ₀ of the kernel in Equation (18). Using the approach described above, the evolution of the pitch over time can be measured using the optimised frequency hyperparameter for each interval. Other information can be determined from hyperparameters. For example, in an example where a state-space model is derived from a model of a dynamical system, hyperparameters are related to physical properties of the system, which can therefore be derived from the optimised hyperparameters. In some examples, hyperparameters of a model may remain fixed (for example, where a state-space model corresponds to a model of a dynamical system).

### Natural Gradient Descent

In the examples described above, the variational distribution q(u) is parameterised in terms of the mean μᵤ and the Cholesky factor Lᵤ of the precision matrix Qᵤᵤ. The Cholesky factor Lᵤ is advantageously restricted to being a lower block-bidiagonal matrix, which allows the computational cost and memory requirements of inference to scale linearly with the number M of inducing points, and further allows learning to be performed in an on-line manner. In optimising the objective function [symbol] with respect to the parameters of the variational distribution, gradient descent is performed using reverse-mode automatic differentiation operators for banded matrices. In the present section, a variant of gradient descent is presented referred to as natural gradient descent. It is observed that in accordance with the present invention, natural gradient descent can be used as an alternative to gradient descent for optimising the parameters of the variational distribution, and retains the linear scaling of the optimisation procedure with respect to the number of inducing variables.

Gradient-based optimisation methods iteratively update the parameters ξ to form a sequence {ξₜ}ₜ₌₀^{T}, where ξ_{T} are converged parameters that sufficiently approximates an optimal set of parameters ξ* according to predefined convergence criteria. The optimal parameters ξ* maximises the objective function [symbol] . A general example of an update rule for updating the parameter vector ξ is given by Equation (19):

ξₜ₊₁=ξₜ−γₜP⁻¹gₜ, (19)

in which: gₜ=V_{ξ}_{^{T}} [symbol] |_{ξ=ξ}_{ₜ}; γₜ is the step size, which may be fixed or may vary with step number; and P is a preconditioning matrix that affects the direction and the size of the change in the parameters induced by the update. Different gradient-based optimisation methods vary from each other by using different preconditioning matrices. For gradient descent (referred to hereafter as ordinary gradient descent), P is an identity matrix. For Adam, P is a diagonal matrix with components given as described in the following section. For L-BFGS, P is an approximation of the Hessian matrix of q(u). For natural gradient descent, P is given by the Fisher information matrix F_{ξ}, which is defined by Equation (20):

F_{ξ}= [symbol] _{q(u)}∇_{ξ}² log(q(u)). (20)

Defining the natural gradient of [symbol] as \tilde{∇}_{ξ} [symbol] =(∇_{ξ} [symbol] )F_{ξ}⁻¹, the update rule (19) for natural gradient descent is written as:

ξₜ₊₁=ξₜ−γₜ\tilde{∇}_{ξ}_{^{T}} [symbol] |_{ξ=ξ}_{ₜ}. (21)

For small changes in ξ, each iteration of the natural gradient method as given by Equation (21) updates ξ in a direction that maximises the KL divergence between q(u) for the updated parameter vector and q(u) for the previous parameter vector. For a given sequence of step sizes, a sequence of updates resulting from Equation (21) has the special property that it is independent of the choice of parameterisation.

For conjugate GP models, natural gradient descent is known to converge in very few steps, and in most cases in one step. For non-conjugate GP models, a robust scheme for achieving rapid convergence using the natural gradient in a non-conjugate Gaussian process model is to use a step size that varies according to two phases. During the first phase, in which the distance |ξₜ−ξ*| takes relatively large values, the step size starts at a small value and increases with step number over a predetermined number of iterations until it reaches a predetermined value. In the second phase, the step size remains at a constant or approximately constant value, for example the predetermined value from the first phase. One example of such a scheme is to increase the step size log-linearly over K steps, such that γ₀=γᵢₙᵢₜᵢₐₗ and γ_{K}=γ_{final}, and to fix γₜ=γ_{final} for t>K. In a specific example, γᵢₙᵢₜᵢₐₗ=10⁻⁴, γ_{final}=10⁻¹, and K=5. Other combinations of γᵢₙᵢₜᵢₐₗ, γ_{final}, and K are also expected to lead to robust performance for γᵢₙᵢₜᵢₐₗ<γ_{final}, as are other schemes in which the sequence {γₜ}ₜ₌₀^{T} has an initial increasing phase followed by a phase in which γₜ remains constant or approximately constant. Robust performance refers to cases in which the sequence {ξₜ}ₜ₌₀^{T} reliably converges, independent of the initial choice ξ₀ of parameters.

An efficient method for calculating the natural gradient will now be described. The natural gradient is related to a first distinguished parameterisation referred to as the natural parameterisation θ[θ₁, θ₂], and a second distinguished parameterisation referred to as the expectation parameterisation η=[η₁,η₂]. General definitions of these parameterisations are known in the art. In terms of the parameterisation described above (the mean μᵤ and Cholesky factor Lᵤ of the precision matrix), the natural and expectations parameterisations are given by Equation (22):

θ=[LᵤLᵤ^{T}μᵤ,−½btd[LᵤLᵤ^{T}]],η[μᵤ,btd[Lᵤ^{-T}Lᵤ⁻¹+μᵤμᵤ^{T}]], (22)

where btd[M] extracts the block-tridiagonal elements of a matrix M and returns them as a vector. It is evident from Equation (22) that the natural and expectation parameters inherit the banded structure of the original parameters. Inverse transformations from the natural and expectation parameters to the original parameters are given by Equations (23) and (24):

ξ=[(−2θ₂)⁻¹θ₁,btd[chol[−2θ₂]]], (23)

ξ=[η₁,btd[chol[(η₂−η₁η₁^{T})⁻¹]]], (24)

where chol denotes the Cholesky factor. These parameter transformations are performed using the sparse inverse subset operator and the reverse sparse inverse subset operator mentioned above. The transposed natural gradient (which appears in the update rule of Equation (21)) is given by

$${∇}_{{ξ}^{{T}^{ℒ}}} = \frac{\partial ξ}{\partial θ} \frac{\partial ℒ}{\partial {η}^{T}} . \qquad ( 25 )$$

The farthest right derivative is evaluated in practice using the chain rule

$$\frac{\partial ℒ}{\partial {η}^{T}} = \frac{\partial ℒ}{\partial ξ} \frac{\partial ℒ}{\partial {η}^{T}} .$$

Using the reverse-mode sensitivities of the banded matrix operators mentioned above, the derivatives not involving [symbol] can be computed in O(Md²) operations. An efficient method of performing natural gradient descent using automatic reverse-mode differentiation libraries is discussed in the article “Natural Gradients in Practice: Non-Conjugate Variational Inference in Gaussian Process Models”, Salimbeni et al, AISTATS 2018.

### Optimising Hyperparameters and Inducing Input Locations

The preceding section described a method of optimising parameters of a variational Gaussian distribution q(u) using natural gradient descent. In addition to these parameters, the variational GP q(ƒ(⋅)) is dependent on hyperparameters of the GP (i.e. coefficients of the LTI-SDE for the state-space model), and also the inducing inputs {zᵢ}ᵢ₌₁^{M}. Natural gradient descent is not suitable for optimising the hyperparameters or the inducing inputs, as neither of these have an associated probability distribution and hence the natural gradient is undefined. Instead, in examples where natural gradient descent is used to optimise the parameters of the variational distribution, a different optimisation method must be used to update the inducing inputs and the hyperparameters. A hybrid scheme is therefore proposed which alternates between steps of natural gradient descent and the other chosen optimisation method.

In a specific example, natural gradient descent is alternated with Adam, which is defined by the update rule of Equation (18) with P given by a diagonal matrix with elements Pᵢᵢ=(\sqrt{vᵢ}+ϵ)mᵢ⁻¹, where mᵢ and vᵢ are the bias-corrected exponential moving averages of the components [gₜ]ᵢ and ([gₜ]ᵢ)² respectively, and ϵ is a fixed small number. In this example, ϵ=10⁻⁸. The step size γ^{Adam} for the Adam update is generally different to the step size y used for the natural gradient update. In one example, the step size γ^{Adam} decreases with the number of update steps, for example exponentially. In another example, the search is performed over a set of candidate step sizes {10^{-κ}}_{κ=0}⁶, and the largest step size that remains stable is chosen.

### Example Data Processing System

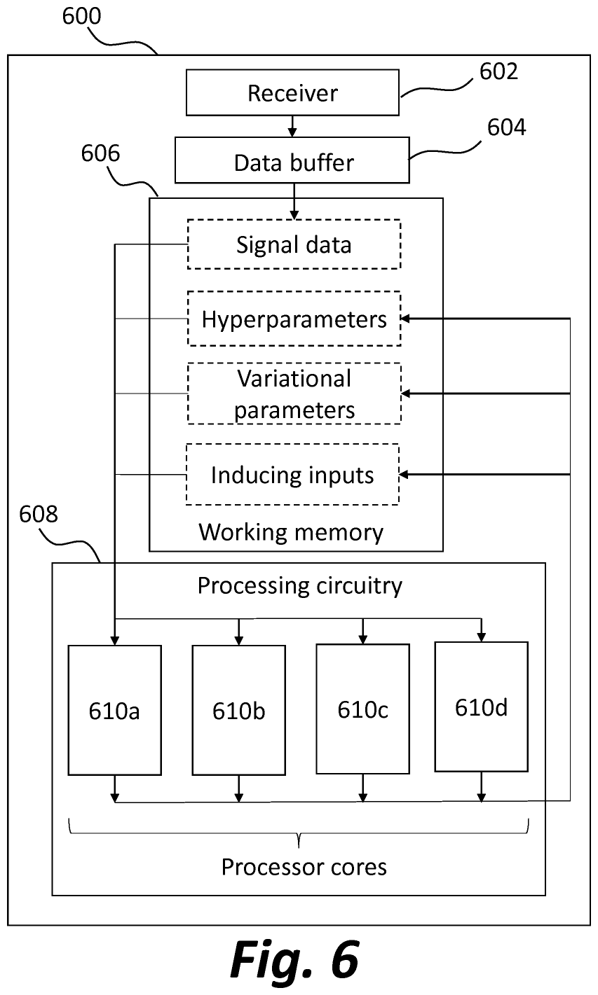

FIG. 6 shows an example of a data processing system 600 arranged to perform signal analysis in accordance with an embodiment of the present invention. The system includes various additional components not shown in FIG. 6 such as input/output devices, a wireless network interface and the like. The data processing system 600 includes a receiver 602, which is arranged to receive a data signal. In the present example, the receiver is a microphone receiver for receiving an audio signal. In other examples, a receiver may include a radio receiver, a camera, a radio antenna, or any other component capable of receiving a data signal.

The data processing system 600 includes a data buffer 604 for temporarily storing a received data signal before passing the received data signal to working memory 606, which in this example includes volatile random-access memory (RAM), in particular static random-access memory (SRAM) and dynamic random-access memory (DRAM). The data processing system 600 may also include non-volatile storage, not shown in FIG. 6.

The working memory 606 is arranged to receive data from the data buffer 604, and to store parameters of a Markovian GP including inducing inputs, parameters of a variational distribution over inducing states, and hyperparameters of the GP model. Block-banded matrices including the precision matrices Q_{ψ} and Qᵤᵤ and their Cholesky factors are stored compactly as described above.

The data processing system 600 includes an inference module 608, which includes processing circuitry configured to perform variational inference in accordance with the present invention. In this example, the inference module 608 includes multiple processor cores 610, of which four processor cores 610a-d are shown. In this example, the processor cores are located within a CPU, though in other examples multiple processor cores may be included for example in one or more processing units such as a graphics processing unit (GPU) or a neural processing unit (NPU). During inference, determination of the marginal distributions q(s(tₙ)) and subsequent determination of the expectation terms in Equation (8) is parallelised across the processor cores once the marginal distributions of all pairs of consecutive inducing states have been determined.

### Example Method

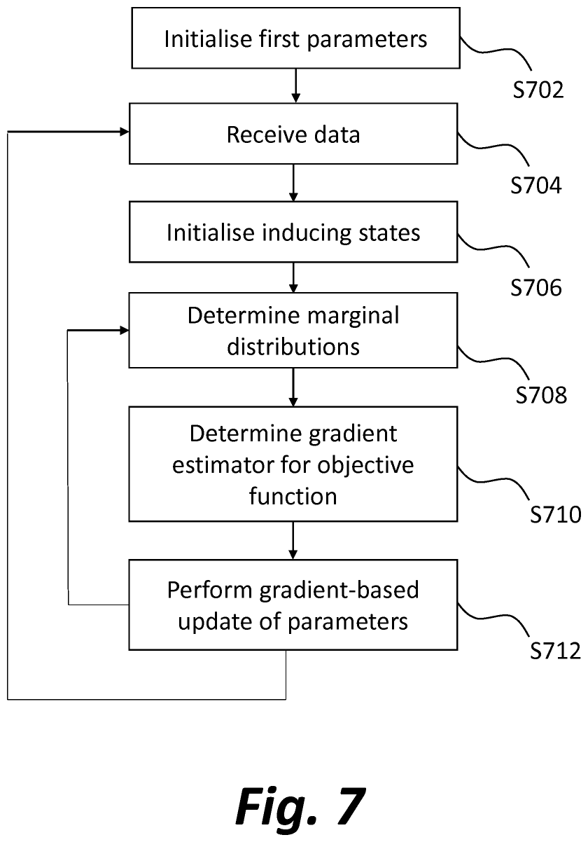

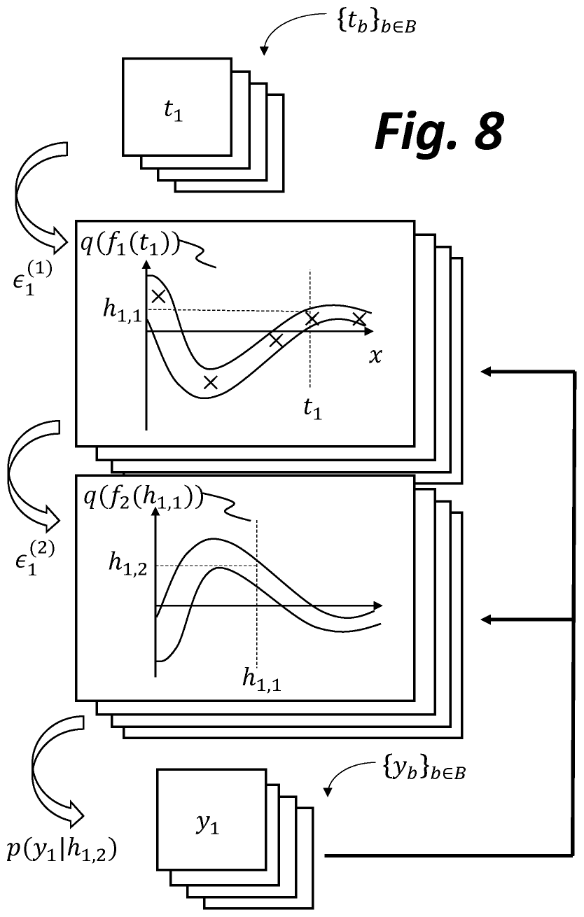

FIG. 7 shows an example of a method performed by the data processing system 600 to process a data signal in accordance with an embodiment of the present invention. The data processing system 600 initialises, at S702, first parameters including hyperparameters in the form of coefficients of a state-space representation of a Markovian GP model. In the present example, the hyperparameters are initialised randomly, though in other examples the hyperparameters may be initialised using a different strategy, for example by deriving the hyperparameters from a dynamical model of a physical system.

The data processing system 600 receives, at S704, a first portion of the signal via the receiver 602. The received first portion is passed to the working memory 606 via the data buffer 604, either continually or in batches. The first portion of the signal is formed of one or more observations or samples. The data processing system 600 initialises, at S706, one or more inducing states. In this example. initialising an inducing state involves two steps—first initialising an inducing input and then initialising entries of a mean vector and a banded Cholesky factor of a precision matrix corresponding to the inducing input. In this example, inducing inputs are initialised sequentially and concurrently with the receiving of the signal. In other words, the one or more inducing inputs are initialised such a rate to allow real-time updating of the GP model as the signal is received. In the present example, the inducing inputs are initialised as predetermined input locations, for example being evenly spaced from each other, though in other examples input locations may be initialised unevenly, for example randomly or in dependence on the input locations of received observations. In some examples, inducing inputs are initialised using K-means clustering of received observations or at input locations of received observations. In the present example, the entries of the mean vector and Cholesky factor of the precision matrix are initialised randomly.

The data processing system 600 determines, at S708, marginal distributions q(s(tₙ)) for one or more observations in a given interval. As explained above, the interval may have a predetermined size or may be dependent on a rate of observations being received. The one or more observations may be a mini-batch formed of a subset of the observations received in that interval, or may include all of the observations received in the interval. The data processing system determines, at S710, an unbiased estimator for a gradient of an objective function [symbol] for observations in the given interval using the reverse mode sensitivities mentioned above. In some examples, an ordinary gradient is determined with respect to parameters Lᵤ, μᵤ of the variational Gaussian distribution q(u), and optionally with respect to the inducing inputs and hyperparameters of the Markovian GP model. Preferably, however, a natural gradient is determined with respect to parameters of the variational Gaussian distribution q(u), as discussed above. In examples where the expectation term in the objective function is intractable, an unbiased stochastic estimator is determined, for example using one or more Monte Carlo samples as shown in Equation (26):

$$\frac{\partial }{\partial {ϕ}_{i}} {𝔼}_{q ( s ( {t}_{n} ) )} [ log p ( {y}_{n} \vert f ( {t}_{n} ) ) ] \approx \frac{1}{S} {\sum }_{s = 1}^{S} \frac{\partial }{\partial {ϕ}_{i}} log p ( {y}_{n} \vert {f}^{( s )} ( {t}_{n} ) ) , \qquad ( 26 )$$

where ϕ={ϕᵢ}ᵢ₌₁^{P} is a set of parameters to be updated, ƒ^{(s)}(tₙ)=Hs^{(s)}(tₙ) with s^{(s)}(tₙ)˜q(s(tₙ)), and S is the number of Monte Carlo samples. In practice, samples of a random variable ϵₙ^{(s)} are drawn from a normalised Gaussian distribution N(0, I_{d}) and a sampled s^{(s)}(tₙ) is determined as s^{(s)}(tₙ)=Pₙμᵥ_{ₙ}+chol(Tₙ+PₙΣᵥ_{ₙ}ᵥ_{ₙ}Pₙ^{T})ϵₙ^{(s)}. This is commonly referred to as the reparameterisation trick, and ensures that the objective function is differentiable with respect to the parameters ϕ, which in turn allows reverse mode differentiation to be performed to determine the gradient. For examples in which the expectation terms are tractable, Monte Carlo sampling is unnecessary.

The data processing system 600 performs, at S712, a gradient-based update of the parameters ϕ using the determined unbiased gradient estimator (using gradient descent, natural gradient descent, and/or variants of these) to increase the value of the objective function [symbol] , Steps S708 to S712 are performed iteratively until either predetermined convergence criteria are satisfied or until a predetermined number of iterations have been performed. The resulting set of parameters may then be transferred to main storage or may remain in the working memory 606 to be used in further computations, for example to determine a predictive distribution over an unknown output y* for a given input location t*.

At a later time, the data processing system 600 receives a second portion of the signal via the receiver 602. Accordingly, the method of FIG. 7 begins again from S704, with new inducing points being initialised within a new interval encompassing the new portion of the signal. In this way, the model is updated adaptively. In some examples, hyperparameters of the Markovian GP model are updated automatically each time a new signal portion is processed. In other examples, hyperparameters are updated only if the performance of the model is determined to deteriorate (for example, if the optimised value of the objective function for the new interval is lower than the optimised value of the objective function for the previous interval by a threshold amount). In this way, the model is adaptively updated as the properties of the signal evolve.

### Application to DGPs

The expressive capacity of a given GP model is limited by the choice of kernel, or equivalently, by the choice of state-space representation for a Markovian GP. Extending a GP model to having a deep structure can improve the expressive capacity of the model. In some embodiments, a deep GP model is formed by composing multiple Markovian GPs with respective state-space representation using inter-domain inducing states as described herein. In an example, a deep GP architecture is based on a composition of functions ƒ(⋅)=ƒ_{L}( . . . , ƒ₂(ƒ₁(⋅)) ), where each component function ƒₗ∈ [symbol] → [symbol] is given a Markovian GP prior with a state space representation sₗ=[ƒₗ(t), ƒₗ⁽¹⁾(t), . . . , ƒₗ^{(d}^{ₗ}⁻¹⁾(t)]^{T}. The joint density for the deep GP model is given by Equation (27):

$$p ( \{ {y}_{n} \} , \{ {h}_{n , l} \} , {s}_{l} ( \cdot ) \} ) = {\prod }_{n = 1}^{N} p ( {y}_{n} \vert {h}_{n , L} ) {\prod }_{l = 1}^{L} p ( {h}_{n , l} \vert {s}_{l} ( {h}_{n , l - 1} ) ) p ( {s}_{l} ( \cdot ) ) , \qquad ( 27 )$$

in which h_{n,0}≡tₙ and the (predetermined) form of p(h_{n,l}|ƒₗ(h_{n,l-1})) determines how the output vector h_{n,l} of a given GP layer depends on the state vector for that layer, and may be chosen to be stochastic or deterministic. In a specific deterministic example, the output of the layer is equal to the output of the latent function, such that p(h_{n,l}|sₗ(h_{n,l-1}))=δ(h_{n,l}−ƒₗ(h_{n,l-1})).

Following the approach of H. Salimbeni and M. Deisenroth in Doubly stochastic variational inference for deep Gaussian processes, Advances in Neural Information Processing Systems, 2017, a variational deep GP is introduced and assumed to be factorizable between layers (referred to as a mean-field assumption), such that each layer of the deep GP is approximated by a variational GP layer q(ƒₗ) with inducing states uₗ=sₗ(Z^{l-1}) defined at a respective set Z^{l} of inducing inputs Z^{l}=(z₁^{l}, . . . , z_{M}_{ₗ}^{l})^{T}. The inducing states are given variational Gaussian distributions q(uₗ)=N(uₗ; μᵤ^{l}, Σᵤᵤ^{l}), where the Cholesky factor Lᵤ^{l} of the precision matrix Qᵤᵤ^{l}=(Σᵤᵤ^{l})⁻¹ is restricted to being a banded matrix of bandwidth l=2dₗ−1 (or, in some examples, a lower block-bidiagonal matrix). The mean μᵤ^{l} and Cholesky factor Lᵤ^{l} of the covariance Σᵤᵤ^{l} for the Gaussian distribution in each layer, along with (optionally) the locations of the inducing inputs Z^{l} and hyperparameters of the kernels kₗ, are determined through optimisation of an objective function given by Equation (28):

$$ℒ = {\sum }_{n = 1}^{N} {𝔼}_{q ( \{ {h}_{n , l} \} , \{ {s}_{i} ( \cdot ) \} )} [ log p ( {y}_{n} \vert {h}_{n , L} ) ] - {\sum }_{l = 1}^{L} KL [ q ( {u}_{l} ) \vert \vert p ( {u}_{l} ) ] , \qquad ( 28 )$$

where the approximate posterior density is given by q({h_{n,l}}, {sₗ(⋅)})=Πₙ₌₁^{N}Πₗ₌₁^{l}p(h_{n,l}|sₗ(h_{n,l-1})) q(sₗ(h_{n,l-1})), where q(sₗ(h_{n,l-1})) is given by Equations (10)-(13) but with tₙ replaced with h_{n,l-1}.

Each of the KL terms in Equation (27) has an analogous expression to that of Equation (14). Due to the intractability of the expectation terms in Equation (27), it is necessary to draw Monte Carlo samples from the distributions q(sₗ(h_{n,l-1})), which is achieved using a reparameterisation trick in which a random variable ϵ^{(l)} is sampled from a normalised Gaussian distribution ϵ^{(l)}˜N(0, I_{d}_{ₗ}) and then passed through a deterministic function to arrive at the required distributions as described above for the single-layer case. This reparameterisation trick allows for reverse-mode differentiation to be applied in order to perform gradient-based optimisation of the objective function of Equation (27).

FIG. 8 schematically shows a training phase for a two-layer DGP model (L=2) in a regression setting of the type described above. Each observation in a dataset has an input portion tₙ and an output portion yₙ. At a given training iteration, an ordered minibatch B of observations is sampled from the dataset. For each observation point in the minibatch, a first random variable ϵ_{b}⁽¹⁾ is drawn from the normalised multivariate Gaussian distribution, and a vector h_{b,1} is determined by evaluating the stochastic function ƒ₁(t_{b}) using the random variable ϵ_{b}⁽¹⁾. A second random variable ϵ_{b}⁽²⁾ is then drawn from the normalised multivariate Gaussian distribution, and a vector h_{b,2} is determined by evaluating the stochastic function ƒ₂(h_{b,1}) using the random variable ϵ_{b}⁽²⁾. The likelihood p(y_{b}|h_{b,2}) is then evaluated at the vector h_{b,2}, and the logarithm of this likelihood is used as a Monte Carlo estimate of the expectation appearing in Equation (15). Reverse-mode differentiation is then performed to determine an unbiased estimator for a gradient of the objective function. In FIG. 8, the above process is illustrated for a first observation (t₁, y₁) in the mini-batch B.

In the examples described above, DGPs were described in which each layer was a Markovian GP implemented in accordance with the present disclosure. In other examples, a Markovian GP implemented in this way may be used as a layer in a DGP comprising other types of GP layers, for example convolutional GP layers or any other type of GP layer suitable for use within a DGP.

### Multi-Dimensional Inputs

In the examples described above, Markovian GP models are used to model data defined on a scalar input domain (for example, time-series data). In other examples, the methods described herein can be extended to be used for data with multiple input dimensions, i.e. for data of the form (x, y), where the input x={xᵢ}ᵢ₌₁^{D}. In one example, an additive model is constructed as a sum of Gaussian processes corresponding to the D dimensions of the input domain, as shown in Equation (29):

$$f ( x ) = {\sum }_{i = 1}^{D} {f}_{i} ( {x}_{i} ) , \qquad ( 29 )$$

in which ƒᵢ˜P (0, kᵢ(xᵢ, x′ᵢ)) and xᵢ∈ [symbol] . For each dimension, the kernel kᵢ(xᵢ, x′ᵢ) has a state-space representation as described above. The additive model may be used for example, in regression problems where observations are expected to depend on multiple covariates. In such cases, a factorised (mean-field) approximation of the overall posterior process is given by q(ƒ₁, . . . ƒ_{D})Πᵢ₌₁^{D}q⁽ⁱ⁾(ƒᵢ), where q⁽ⁱ⁾(ƒᵢ) are component variational GPs parameterised using the Markovian GP formulation described in the present application, with independent inducing states for each input dimension.

In some applications, such as in audio processing and telecommunications, a signal (referred to as a mixture) is formed as a superposition of unknown underlying components (referred to as sources), often nonlinearly transformed and modified by noise. Recovering the underlying sources is referred to as source separation. An application of source separation for audio signals is the so-called cocktail party problem, in which the objective is to isolate the speech of a single person in a room with several people speaking (and, possibly, other sounds). Source separation may be performed using the additive model of Equation (29), by defining an extended state space vector S(t)=(s₁(t), . . . s_{D}(t))^{T} as a concatenation of states for a set of D underlying component Markovian GPs, and an extended observation matrix H(t)=(H₁(t), . . . H_{D}(t)). Each of the component Markovian GPs is associated with a variational GP with a respective set of inducing points with a respective variational distribution to be determined by optimising a combined objective function. The resulting GPs can be extracted using the extended observation matrix H, thus solving the source separation problem. Using the present formulation of Markovian GP inference, source separation can be performed rapidly, for example in real time or near real time depending on the rate of sampling of the data.

### FURTHER EMBODIMENTS AND MODIFICATIONS

The above embodiments are to be understood as illustrative examples of the invention. Further embodiments of the invention are envisaged. For example, the present invention may be implemented using different hardware to the data processing system shown in FIG. 6, for example using a distributed computing system and/or in accordance with a client-server arrangement.

In some examples, the present invention may be used within other types of composite GP models, for example in models with multi-dimensional outputs modelled by correlated GPs. In one example, the present Markovian GP model is used in Gaussian process factor analysis of neural activity, in which measurements of neural activity are taken over a period of time for multiple neurons in a human or animal brain. The neural activity measurements at a given time are correlated and are assumed to be noisy observations of an underlying low-dimensional neural state. This method allows for neural activity data to be meaningfully analysed from a single trial, which is preferable to averaging measurements over multiple trials, because neural conditions generally vary even for nominally identical trials. In accordance with an embodiment of the present invention, each dimension of the neural state is represented by a Markovian GP with a respective characteristic time-scale and parameterised as described above. A multi-output composite GP is described by an extended state space vector S(t)=(s₁(t), . . . s_{D}(t))^{T}, which is projected onto k measured outputs using an extended observation matrix H∈ [symbol] ^{k×Dd}. Gaussian process factor analysis is learned by training the composite GPs, along with the extended observation matrix. In this setting, the present invention allows for efficient real-time or near real-time analysis and/or visualisation of neural activity within the human or animal brain.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-15. (canceled)

16. A system comprising:
a data interface configured to receive data representing observations of a state of a physical system at a plurality of times;
a memory configured to store:
the data; and
parameters of a multivariate Gaussian distribution over a set of inducing states, each inducing state having components corresponding to a Markovian Gaussian process (GP) and one or more derivatives of the Markovian GP at a respective inducing time of a plurality of inducing times, wherein the parameters comprise a mean vector and a lower block-banded Cholesky factor of a precision matrix for the multivariate Gaussian distribution; and
one or more processors configured to:
initialise the ordered plurality of inducing inputs;
initialise the parameters of the multivariate Gaussian distribution;
iteratively modify the parameters of the multivariate Gaussian distribution to increase an objective function corresponding to a variational lower bound of a marginal log-likelihood of the observations under the Markovian GP, the objective function being a function of the lower block-banded Cholesky factor of the precision matrix; and
predict, using the modified parameters of the multivariate Gaussian distribution, the state of the physical system at a further time.

17. The system of claim 16, wherein the further time is later than any of the plurality of times.

18. The system of claim 16, wherein the operations further comprise:
determining hyperparameters for the Markovian GP; and
deriving one or more physical properties of the physical system from the determined hyperparameters for the Markovian GP.

19. The system of claim 16, wherein the operations comprise initialising the inducing inputs sequentially and concurrently with the receiving of the data.

20. The system of claim 16, wherein initialising the parameters of the multivariate Gaussian distribution comprises allocating a first region of the memory to store a dense matrix comprising in-band elements of the lower block-banded Cholesky factor of the precision matrix.

21. The system of claim 16, wherein the number of inducing inputs is less than the number of observations in the plurality of observations.

22. A computer-implemented method comprising:
initialising an ordered plurality of inducing inputs;
initialising parameters of a multivariate Gaussian distribution over a set of inducing states, each inducing state having components corresponding to a Markovian GP and one or more derivatives of the Markovian GP at a respective one of the inducing inputs, wherein the initialised parameters comprise a mean vector and a banded Cholesky factor of a precision matrix for the multivariate Gaussian distribution; and
iteratively modifying the parameters of the multivariate Gaussian distribution, to increase or decrease an objective function corresponding to a variational lower bound of a marginal log-likelihood under the Markovian GP of data comprising a plurality of observations associated with respective ordered input values, the objective function being a function of the banded Cholesky factor of the precision matrix.

23. The computer-implemented method of claim 22, wherein initialising the parameters of the multivariate Gaussian distribution comprises allocating a first memory region to store a dense matrix comprising in-band elements of the banded Cholesky factor of the precision matrix.

24. The computer-implemented method of claim 22, comprising iteratively modifying the inducing inputs to increase or decrease the objective function.

25. The computer-implemented method of claim 22, comprising:
receiving a data stream comprising the plurality of observations; and
initialising the inducing inputs sequentially and concurrently with the receiving of the data stream.

26. The computer-implemented method of claim 25, wherein first input values associated with first observations of the plurality of observations lie within a first interval, and second input values associated with second observations of the plurality of observations lie within a second interval different from the first interval, the method comprising:
receiving the first observations;
initialising first inducing inputs within the first interval;
initialising first parameters of the multivariate Gaussian distribution corresponding to first inducing states associated with the first inducing inputs;
iteratively modifying the first parameters of the multivariate Gaussian distribution to increase or decrease an objective function for the first interval;
receiving the second observations;
initialising second parameters of the multivariate Gaussian distribution corresponding to second inducing states associated with the second inducing inputs; and
iteratively modifying the second parameters of the multivariate Gaussian distribution to increase or decrease an objective function for the second interval.

27. The computer-implemented method of claim 22, wherein the number of inducing inputs is less than the number of observations.

28. The computer-implemented method of claim 22, wherein iteratively modifying the parameters of the multivariate Gaussian distribution comprises performing a natural gradient update.

29. The computer-implemented method of claim 22, wherein the data is time-series data and the ordered input values correspond to times.

30. The computer-implemented method of claim 29, wherein each of the observations corresponds to a sample from an audio file.

31. The computer-implemented method of claim 29, wherein each of the observations corresponds to a neural activation measurement.

32. The computer-implemented method of claim 29, wherein each of the observations corresponds to a measurement of a radio frequency signal.

33. The computer-implemented method of claim 22, wherein the Markovian GP is a component GP in a composite GP comprising a plurality of further component GPs.

34. The computer-implemented method of claim 31, wherein the composite GP is an additive GP and each of the component GPs of the composite GP represents a source underlying the plurality of observations, the method comprising training the Markovian GP and the plurality of further GPs to determine a distribution of each of the sources underlying the plurality of observations.

35. One or more non-transitory computer-readable media storing instructions executable by one or more processors, wherein the instructions, when executed, cause the one or more processors to perform operations comprising:
initialising an ordered plurality of inducing inputs;
initialising parameters of a multivariate Gaussian distribution over a set of inducing states, each inducing state having components corresponding to a Markovian GP and one or more derivatives of the Markovian GP at a respective one of the inducing inputs, wherein the initialised parameters comprise a mean vector and a banded Cholesky factor of a precision matrix for the multivariate Gaussian distribution; and
iteratively modifying the parameters of the multivariate Gaussian distribution, to increase an objective function corresponding to a variational lower bound of a marginal log-likelihood under the Markovian GP of data comprising a plurality of observations associated with respective ordered input values, the objective function being a function of the banded Cholesky factor of the precision matrix.
